(19) United States
(12) Patent Application Publication
(10) Pub. No.: US 2006/0217854 A1
(43) Pub. Date: Sep. 28, 2006

(54) Travel device and self-propelled cleaner

(75) Inventors: Hiroyuki Takenaka, Osaka (JP); Takao Tani, Osaka (JP)

Correspondence Address: Yokoi & Co., U.S.A., Inc., 13700 Marina Pointe Drive #723, Marina Del Ray, CA, 90292, US

(73) Assignee: Funai Electric Co., Ltd., Osaka (JP)

(21) Appl. No.: 11/386,411

(22) Filed: Mar. 22, 2006

(30) Foreign Application Priority Data
Mar. 24, 2005 (JP) JP2005-086330

(51) Int. Cl. G01C 22/00

(52) U.S. Cl. 701/23; 701/25

(57) ABSTRACT

A travel device is capable of determining a deviation angle by which the traveling direction thereof deviates from a travel line parallel to a wall by a simple method and of correcting the deviation of the traveling direction. when the travel device travels along a wall along a travel line parallel to the wall and at a fixed distance from the wall, a deviation angle by which the traveling direction of the body deviates from the travel line parallel to the wall by using: tan θ=H/L, where θ is deviation angle, L is a predetermined travel distance and H is a distance of deviation of the body from the travel line parallel to the wall.

### BACKGROUND OF THE INVENTION

1. Field of the Invention

The present invention relates to a travel device provided with a drive mechanism capable of steering and driving operations and, more particularly, to a self-propelled cleaner provided with a cleaning mechanism and capable of automatically traveling along a predetermined traveling route for cleaning.

2. Description of the Related Art

Self-propelled cleaners are disclosed in, for example, JP-A Nos. 07-295636 and 11-025398. The known self-propelled cleaner includes a body, a drive mechanism capable of steering and driving operations and a cleaning mechanism. The self-propelled cleaner travels automatically along a predetermined traveling route for cleaning, photodetectors or the like, namely, side-wall detectors, placed on side surfaces of the body measure the distance between the wall and the self-propelled cleaner to keep a fixed distance between the wall and the self-propelled cleaner and the self-propelled cleaner travels parallel to the wall.

When the photodetectors included in the wall detector measures the distance between the self-propelled cleaner and the wall by projecting an infrared beam toward the wall and detecting the reflected infrared beam, the output of the wall detector includes an error caused by the material and color of the wall. Consequently, the distance between the wall and the self-propelled cleaner cannot be accurately measured and the self-propelled cleaner cannot travel parallel to the wall.

### SUMMARY OF THE INVENTION

The present invention has been made in view of the foregoing problem and it is therefore an object of the present invention to provide a travel device capable of determining a deviation angle by which the traveling direction thereof deviates from a travel line parallel to a wall by a simple method and of correcting the deviation of the traveling direction.

A travel device according to the present invention capable of traveling along a travel line parallel to and at a fixed distance from a wall, and provided with a body, a drive mechanism capable of carrying out steering and driving operations, a gyroscopic sensor capable of determining an angular direction of the body, a travel distance measuring mechanism for measuring travel distance, and a wall detector for detecting the wall includes: a calculating processor for calculating a deviation angle by which the traveling direction of the body deviates from the travel line parallel to the wall by using:
tan θ=H/L (1)
where θ is deviation angle, L is predetermined travel distance and H is distance of deviation of the body from the travel line parallel to the wall; and a traveling direction correcting mechanism for correcting the traveling direction of the body on the basis of the calculated deviation angle θ calculated by the calculating processor.

The travel device according to the present invention is provided with the drive mechanism capable of carrying out the steering and driving operations, the gyroscopic sensor capable of determining the angular direction of the body, the travel distance measuring mechanism for measuring a travel distance traveled by the body, and the wall detector for detecting the wall. The travel device is capable of traveling parallel to the wall along a travel line parallel to and at a fixed distance from the wall by using the output of the wall detector. When the travel device travels along the wall, the output of the wall detector is monitored and the direction of the body is controlled so that the output of the wall detector is fixed.

The travel device includes the calculating processor for calculating a deviation angle by which the traveling direction of the body deviates from the travel line parallel to the wall by using an expression: tan θ=H/L, where θ is deviation angle, L is predetermined travel distance and H is distance of deviation of the body from the travel line parallel to the wall, and the angular direction correcting mechanism for correcting the traveling direction of the body on the basis of the calculated deviation angle θ calculated by the calculating processor. The deviation angle θ, namely, the angle between the traveling direction of the body and the travel line parallel to the wall, is calculated by using the travel distance L and the distance H of deviation of the body from the travel line parallel to the wall, and the traveling direction of the body is corrected on the basis of the deviation angle θ. Thus the deviation angle θ of the traveling direction of the body with respect to the wall can be determined by a simple method, and the deviation angle can be corrected so that the body travels accurately along the wall. The travel device does not need any special sensors other than the wall detector and the travel distance measuring mechanism and hence the travel device can be manufactured at a low manufacturing cost.

Normally, the deviation angle θ is calculated by using Expression (1). When the distance H of deviation is very small as compared with the predetermined distance L and the deviation angle θ is an infinitesimal, θ=H/L. Therefore, an expression: θ=H/L may be used for calculation instead of Expression (1).

A travel device according to the present invention capable of traveling along a travel line parallel to and at a fixed distance from a wall, and provided with a body, a drive mechanism capable of carrying out steering and driving operations, a gyroscopic sensor capable of determining the angular direction of the body, a travel distance measuring mechanism for measuring a travel distance traveled by the body, and a wall detector for detecting the wall includes: a calculating processor for calculating a deviation angle by which the traveling direction of the body deviates from the travel line parallel to the wall by using:
θ=H/L (2)
where θ is angle of deviation, L is a predetermined distance and H is distance of deviation of the body from the travel line parallel to the wall; and an angular direction correcting mechanism for correcting the traveling direction of the body on the basis of the calculated deviation angle θ calculated by the calculating processor.

In the travel device according to the present invention, the distance H of deviation may be calculated by using an output of the wall detector.

In the travel device according to the present invention, the distance H of deviation can be calculated by using the difference between an output of the wall detector provided at the start of measuring travel distance and an output of the wall detector provided upon the coincidence of a measured travel distance with the predetermined distance L.

In the travel device according to the present invention, the travel distance measuring mechanism may include rotary encoders capable of counting the number of rotation of a wheel.

A self-propelled cleaner according to the present invention includes a cleaning mechanism

The self-propelled cleaner is capable of performing a cleaning operation during an automatic traveling operation.

### BRIEF DESCRIPTION OF THE DRAWINGS

The above and other objects, features and advantages of the present invention will become more apparent from the following description taken in connection with the accompanying drawings, in which:

FIG. 1 is a perspective view of a self-propelled cleaner in a preferred embodiment according to the present invention;

FIG. 2 is a bottom view of the self-propelled cleaner shown in FIG. 1;

FIG. 3 is a block diagram of the self-propelled cleaner shown in FIG. 1;

FIG. 4 is a flowchart of an automatic cleaning procedure to be carried out by the self-propelled cleaner shown in FIG. 1;

FIG. 5 is a diagrammatic view of an example of a predetermined traveling route to be followed by the self-propelled cleaner shown in FIG. 1 to carry out the automatic cleaning procedure shown in FIG. 4;

FIG. 6 is a flowchart of an along-wall traveling procedure to be carried out in step 240 in the automatic cleaning procedure shown in FIG. 4;

FIG. 7 is a diagrammatic view of assistance in explaining the along-wall traveling procedure shown in FIG. 6; and

FIG. 8 is a flowchart of an along-wall traveling procedure in a modification of the along-wall traveling procedure shown in FIG. 6.

### DESCRIPTION OF THE PREFERRED EMBODIMENTS

A preferred embodiment of the present invention will be described in the following order.

(1) External Configuration of Self-propelled Cleaner

(2) Internal Configuration of Self-propelled Cleaner

(3) Operation of Self-propelled Cleaner

(4) Modifications

(5) Effect of the Invention

(1) External Configuration of Self-Propelled Cleaner

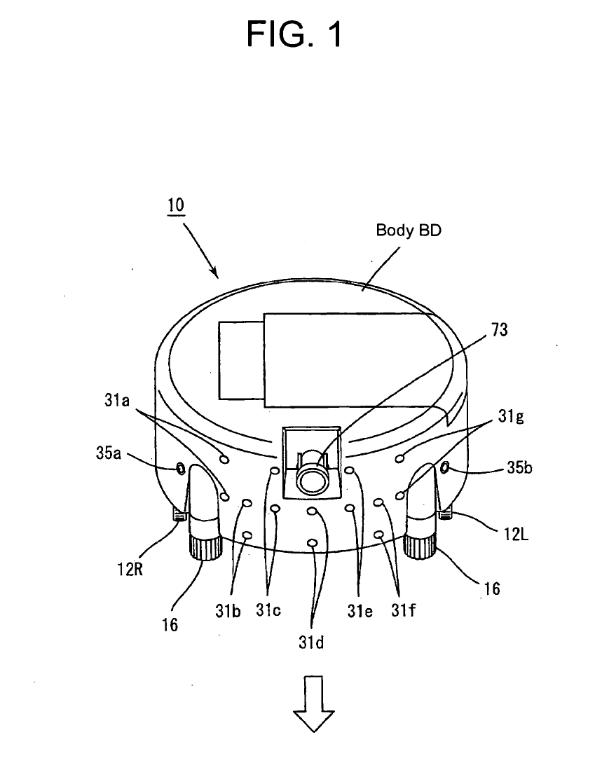

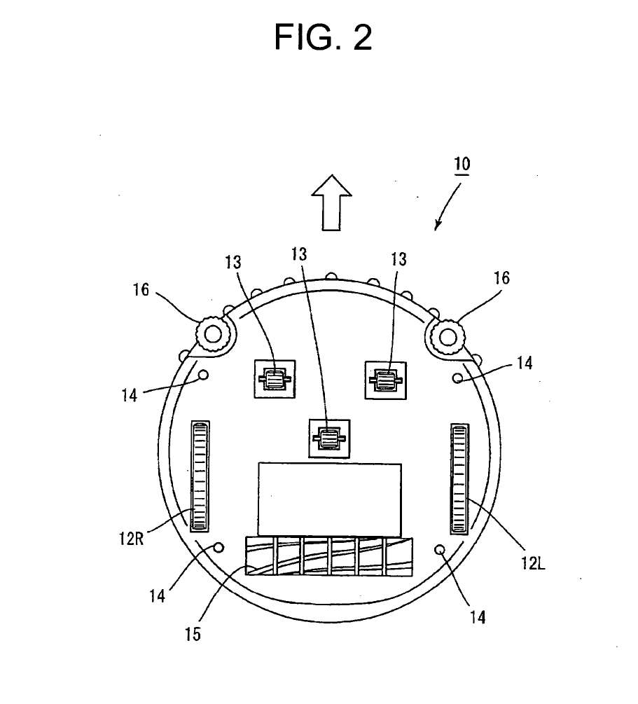

FIG. 1 is a perspective view of a self-propelled cleaner 10 in a preferred embodiment according to the present invention and FIG. 2 is a bottom view of the self-propelled cleaner 10 shown in FIG. 1. The blank arrow show in FIG. 1 indicates a forward traveling direction of the self-propelled cleaner 10. The self-propelled cleaner 10 has a substantially cylindrical body BD and two driving wheels 12R and 12L attached to the bottom wall of the body BD, and an infrared CCD sensor 73, namely, a photodetector, attached to a central part of the front side of the body BD. The driving wheels 12R and 12L are driven individually to move the self-propelled cleaner 10 for straight, forward traveling, backward traveling and turning about a predetermined axis.

Seven ultrasonic sensors 31a to 31g, which will be inclusively indicated at 31 in some cases, namely, obstacle detectors for detecting an obstacle in front of the self-propelled cleaner 10, are arranged in a part of the front surface of the body BD below the infrared CCD sensor 73. Each of the ultrasonic sensors 31 has an ultrasonic wave emitting device that emits an ultrasonic wave, and an ultrasonic wave receiving device that receives the ultrasonic wave emitted by the ultrasonic wave emitting device and reflected by an obstacle in front of the self-propelled cleaner 10, such as a wall on a traveling route to be followed by the self-propelled cleaner 10. The distance between the self-propelled cleaner 10 and a wall on the traveling route can be calculated from time between the emission of the ultrasonic wave by the ultrasonic wave emitting device and the reception of the reflected ultrasonic wave by the ultrasonic wave receiving device. The ultrasonic sensor 31d is disposed in a central part of the front surface of the body BD. The ultrasonic sensors 31a and 31g, the ultrasonic sensors 31b and 31f, and the ultrasonic sensors 31c and 31e are disposed symmetrically, respectively, with respect to a vertical line passing the ultrasonic sensor 31d. When the traveling direction of the self-propelled cleaner 10 is perpendicular to a wall standing ahead of the self-propelled cleaner 10, the distances measured respectively by the two ultrasonic sensors 31 disposed symmetrically with respect to the vertical line are equal.

Pyroelectric sensors 35a and 35b are disposed in right and left parts, respectively, of the front surface of the body BD. The pyroelectric sensors 35a and 35b are sensitive to infrared radiation. The pyroelectric sensors 35a and 35b are capable of detecting a person near the body BD by sensing infrared radiation emitted by the person's body. Pyroelectric sensors 35 (35c and 35d), not shown in FIG. 1, are disposed in right and left parts, respectively, of the back surface of the body BD. Thus, objects in an angular range of 360° around the body BD can be detected.

Side-wall detectors 36 (36R and 36L), namely, photodetectors, not shown in FIG. 1, are disposed in right and left side surfaces, respectively, of the body BD. Each of the side-wall detectors 36 detects a wall standing beside the self-propelled cleaner 10 to keep a predetermined distance between the self-propelled cleaner 10 and the wall while the self-propelled cleaner 10 is traveling. The positions of the side-wall detectors 36 will be explained later.

Referring to FIG. 2, the two driving wheels 12R and 12L are disposed in right and left parts on the right and the left side of the center of the bottom wall of the body BD, respectively, of to the bottom wall of the body BD. Three support wheels 13 are arranged in a front part of the bottom wall of the body BD. Step detectors 14 are disposed in an upper right-hand part, a lower right-hand part, an upper left-hand and a lower left-hand part, respectively, as viewed in FIG. 2. The step detectors 14 detect irregularities and steps in a surface on which the self-propelled cleaner 10 travels. A main brush 15 is held on the bottom wall of the body BD in a lower part, as viewed in FIG. 2, of the bottom wall of the body BD. A main brush driving motor 52, not shown in FIG. 2, drives the main brush 15 for rotation to raise dust by brushing from the surface. The main brush 15 is placed in a suction opening formed in the bottom wall. Dust raised by brushing with the rotating main brush 15 is sucked through the suction opening into the body BD. Side brushes 16 are disposed in an upper right-hand part and an upper left-hand part, as viewed in FIG. 2, of the bottom wall of the body BD.

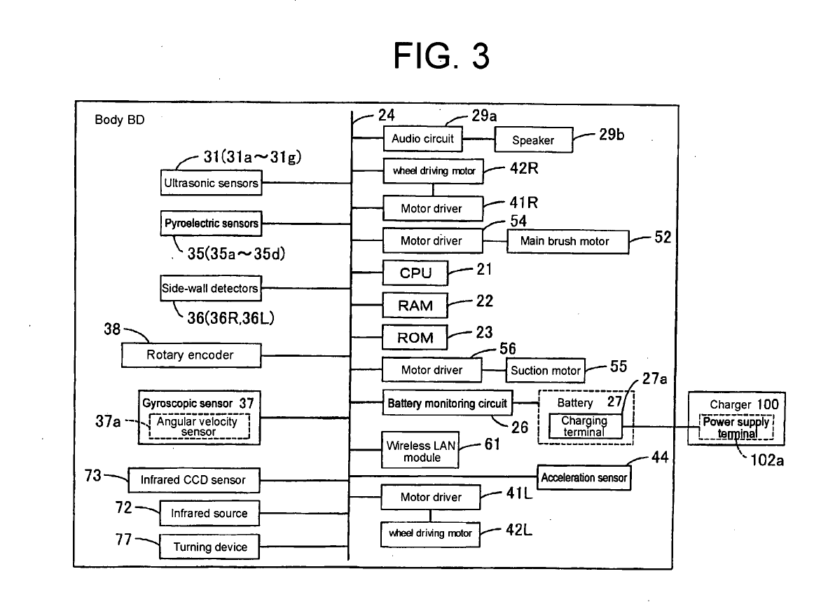

Detectors included in the self-propelled cleaner 10 other than the ultrasonic sensors 31, the pyroelectric sensors 35, the step detectors 14 and the side-wall detectors 36 will be described later in connection with FIG. 3.

(2) Internal Configuration of Self-Propelled Cleaner

Referring to FIG. 3 showing, in a block diagram, the internal configuration of the self-propelled cleaner 10 shown in FIGS. 1 and 2, a CPU 21, namely, a controller, a ROM 23 and a RAM 22 contained in the body BD are connected to a bus 24. The CPU 21 performs various control operations according to control programs and parameter tables stored in the ROM 23 and uses the RAM 22 as a work area.

A battery 27 is held in the body BD. The CPU 21 is able to monitor the residual capacity of the battery 27 from the output of a battery monitoring circuit 26. The battery 27 is provided with a charging terminal 27a. A power output terminal 102a of a charger 100 is connected to the charging terminal 27a to charge the battery 27. The battery monitoring circuit 26 monitors mainly the voltage of the battery 27 to measure the residual capacity of the battery 27. An audio circuit 29a is contained in the body BD and is connected to the bus 24. The audio circuit 29a generates voice signals. A speaker 29b converts audio signals generated by the audio circuit 29a into voices and radiates the voices.

As shown in FIGS. 1 and 2, the body BD is provided with the ultrasonic sensors 31a to 31g for detecting obstacles lying ahead of the self-propelled cleaner 10, the pyroelectric sensors 35a to 35d for detecting persons and the step detectors 14. The body BD is provided with the side-wall detectors 36R and 36L, not shown in FIGS. 1 and 2, in addition to the sensors and the detectors shown in FIGS. 1 and 2. Each of the side-wall detectors 36R and 36L is a photodetector having an infrared emitting device that emits an infrared beam and an infrared receiving device that receives the infrared beam emitted by the infrared emitting device and reflected by a wall. The side-wall detectors 36R and 36L may be ultrasonic sensors. The body BD is provided further with a gyroscopic sensor 37 provided with an angular velocity sensor 37a. The angular velocity sensor 37a measures a change in the angular velocity of the body BD when the traveling direction of the body BD changes. The angular direction of the body BD can be determined by integrating outputs of the angular velocity sensor 37a representing measured changes in the angular velocity of the body BD.

The self-propelled cleaner 10 is provided with a driving mechanism. The driving mechanism includes motor drivers 41R and 41L, wheel driving motors 42R and 42L, and gear trains interlocking the wheel driving motors 42R and 42L and the driving wheels 12R and 12L. The motor drivers 41R and 41L drive the driving wheels 41R and 41L, respectively. When the traveling direction of the self-propelled cleaner 10 changes, the motor drivers 41R and 41L minutely control the respective rotating directions and rotating angles of the driving wheels 12R and 12L, respectively. The motor drivers 41R and 41L generate drive signals specified by control signals provided by the CPU 21. The gear trains and the driving wheels 12R and 12L may be of any suitable types. The driving wheels 12R and 12 may be wheels provided with a rubber tire, and endless belts may be employed instead of the gear trains.

The body BD is provided with the travel distance measuring mechanism including the rotary encoders 38. The rotary encoders 38 are combined with the wheel driving motors 42R and 42L, respectively. A travel distance traveled by the body BD can be calculated by using the respective numbers of rotation of the driving wheels 12R and 12L.

Driven wheels may be disposed near the driving wheels and supported for rotation, and the rotary encoders 38 may count the numbers of rotation of the driven wheels instead of directly counting the respective numbers of rotation of the driving wheels. Thus actual numbers of rotation can be determined even if the driving wheels slip. An acceleration sensor 44 measures accelerations in directions parallel to three axes, namely, an X-axis, a Y-axis and a Z-axis.

As shown in FIG. 2, the cleaning mechanism of the self-propelled cleaner 10 includes the two side brushes 16 supported on the bottom wall of the body BD, the main brush 15 supported on a central part of the bottom wall of the body BD, and a suction fan, not shown, for sucking dust raised by the main brush 15 into a dust box. The main brush motor 52 drives the main brush 15. A fan motor 55 drives the suction fan. Motor drivers 54 and 55 supply driving power to the main brush motor 52 and the fan motor 55, respectively. The CPU 21 properly controls a cleaning operation using the main brush 15 according to the condition of the floor surface, the condition of the battery and instructions provided by the operator.

The body BD is provided with a radio LAN module 61. The CPU 21 is able to communicate with external LANs according to a protocol. It is supposed that the radio LAN module 61 can be connected to an access point, not shown, connected by a router or the like to an external wide-area network, such as the Internet. The radio LAN module 61 is able to send out and receive ordinary males and to browse Web sites. The radio LAN module 61 is provided with a standard card slot and a standard radio LAN card inserted in the card slot. Another standard card can be inserted in the card slot.

The body BD is provided with an infrared source 72 and an infrared CCD sensor 73. An image signal provided by the infrared CCD sensor 73 is transmitted through the bus 24 to the CPU 21. The CPU 21 carries out various processes using the image signal. The infrared CCD sensor 73 is provided with an optical system capable of capable of forming images of objects lying in front of the self-propelled cleaner 10. The infrared CCD sensor 73 receives infrared rays emerged from objects in the visual field of the optical system and generates electric signals representing the incident infrared rays. More concretely, the infrared CCD sensor 73 is provided with many photodiodes forming image points and arranged on the image forming plane of the optical system. The photodiodes generates electric signals of electric energy levels respectively corresponding to the energy levels of the incident infrared rays. The photodiodes of the infrared CCD sensor 73 temporarily store electric charges. The photodiodes are accessed sequentially to produce image signals. The image signals thus produced are sent to the CPU 21 in a proper manner.

(3) Operation of Self-Propelled Cleaner

The operation of the self-propelled cleaner 10 will be described. The self-propelled cleaner 10 operates for an automatic traveling operation and a cleaning operation according to the control programs stored beforehand in the ROM 23. If the step detector 14 detects irregularities in the wall or the floor surface while the self-propelled cleaner 10 is in the automatic traveling and the cleaning operation, the traveling operation of the self-propelled cleaner 10 is controlled according to the control program.

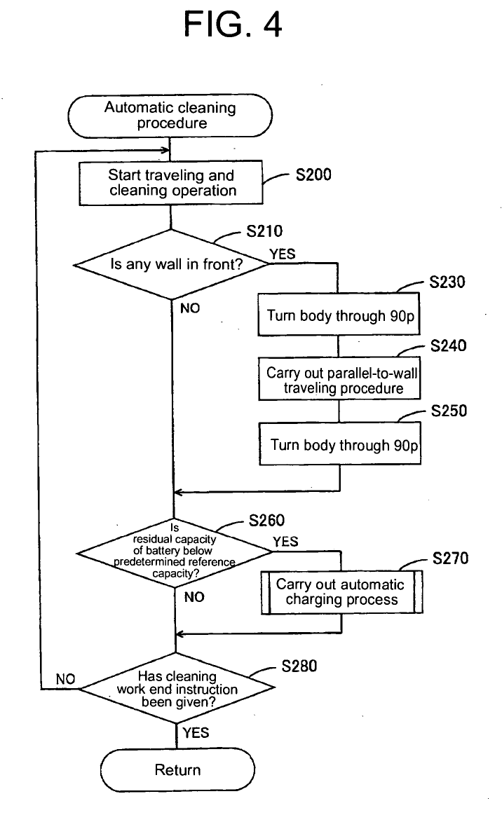

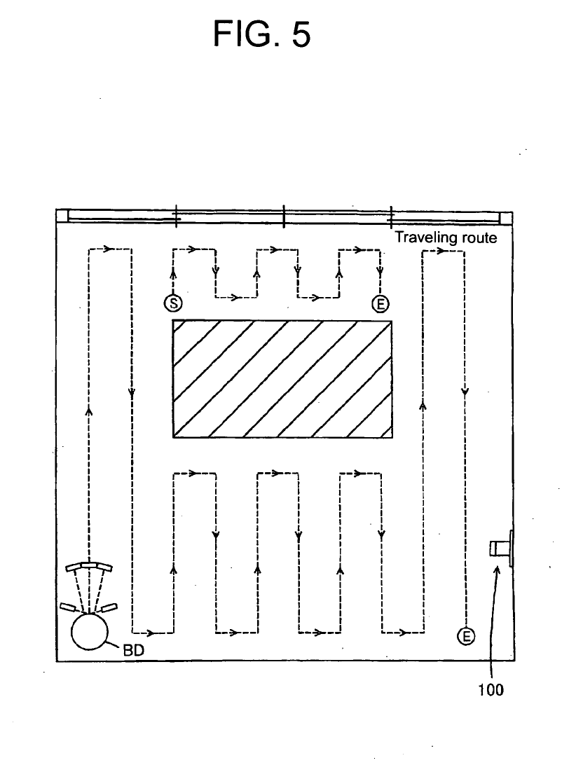

An automatic cleaning procedure to be carried out by the self-propelled cleaner 10 will be described. FIG. 4 is a flowchart of the automatic cleaning procedure to be carried out by the self-propelled cleaner 10 and FIG. 5 is a typical view of an example of a predetermined traveling route to be followed by the self-propelled cleaner 10 to carry out the automatic cleaning procedure shown in FIG. 4. A traveling and cleaning operation is started in step S200. In step S200, the wheel driving motors 42R and 42L are driven to move the body BD straight ahead, driving operations are controlled on the basis of signals provided by the sensors and the detectors of the self-propelled cleaner 10, and the main brush motor 52 and the suction motor 55 are driven for cleaning work.

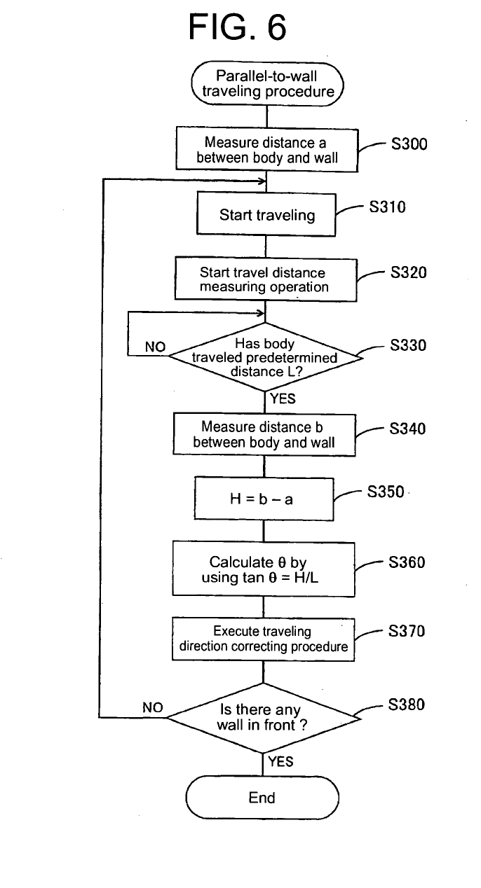

Then, in step S210, a query is made to see if any wall in front is detected; that is, a query is made to see if the ultrasonic sensors 31 have detected any wall lying ahead of the body BD. If the response to the query made in step S210 is affirmative, the body BD is turned through an angle of 90° in step S230 so that the body BD may travel in a direction substantially parallel to the wall. For example, when a wall in an upper part, as viewed in FIG. 5 is detected after the self-propelled cleaner 10 has started the traveling and cleaning operations at a starting point in FIG. 5, the body BD is turned to the right through an angle of 90°. Then, a parallel-to-wall traveling procedure shown in FIG. 6 is carried out in step S240. In the parallel-to-wall traveling process, the main brush driving motor 52, the suction motor 55 are driven for the cleaning work and the self-propelled cleaner 10 is controlled so as to travel parallel to the wall for the traveling and cleaning operations. The traveling direction of the body BD is corrected every time the body BD has traveled the predetermined distance L on the basis of data provided by the side wall detectors 36 and the rotary encoders 38 to make the body BD travel parallel to the wall.

After the body BD has traveled a predetermined distance along the wall in step S240, the body BD is turned to the right through an angle of 90° in step S250. Consequently, the body BD starts traveling away from the wall in a direction perpendicular to the wall.

After step S250 has been executed or if the response to the query made in step S210 is negative, the residual capacity of the battery 27 is examined in step S260 to see if the residual capacity of the battery 27 has decreased below a predetermined reference capacity. If it is decided that the residual capacity of the battery 27 has decreased below a predetermined reference capacity in step S260, an automatic charging process is carried out in step S270. In the automatic charging process, the body BD is made to travel automatically to the charger 100 placed on a predetermined wall in the room to be cleaned, the charging terminal 27a of the body BD is connected to the power supply terminal 102a of the charger 100 to charge the battery 27.

After step S270 has been executed or when the response to the query made in step S260 is negative, a query is made in step S280 to see if a cleaning work end instruction has been given. The procedure returns to step S200 if the response to the query in step S280 is negative or the automatic cleaning procedure is ended if the response to the query in step S280 is affirmative.

The parallel-to-wall traveling procedure shown in FIG. 6 to be carried out in step S240 of the automatic cleaning procedure shown in FIG. 4 will be described. The distance a between the body BD and the wall standing beside the body BD is measured by the side-wall detector 36 in step S300. The distance a is calculated by using the intensity of the infrared beam received by the infrared receiving device and a table showing distances respectively corresponding to intensities of the infrared beam. When the body BD is turned through an angle of 90° in step S230 of the automatic cleaning procedure shown in FIG. 4 the body BD is at the distance a from the wall. The body BD is expected to travel so as to keep the distance a from the wall. The traveling direction of the body BD is corrected so that the body BD is always at the distance a from the wall while the body BD travels along the wall.

The body BD starts traveling in step S310; the wheel driving motors 42R and 42L are driven such that the body BD travels straight ahead, and the main brush motor 52 and the suction motor 55 are driven for cleaning work. Then, a travel distance measuring operation is started in step S320. A travel distance traveled by the body BD is calculated by using the respective numbers of rotation of the driving wheels 12R and 12L counted by the rotary encoders 38 of the travel distance measuring mechanism.

Then, a query is made in step S330 to see if the body BD has traveled the predetermined distance L. It is decided whether or not the body BD has traveled the predetermined distance L since the start of the travel in step S310 from the outputs of the rotary encoders 38. The predetermined distance L may be an optional distance. Step S330 is executed again if the response to the query made in step S330 is negative. The distance b between the body BD and the wall is measured by the side-wall detector 36 in step S340 if the response to the query made in step S330 is affirmative.

Then, the distance H of deviation of the body BD from the travel line parallel to the wall after the body BD has traveled the predetermined distance L is calculated by using an expression H=b−a in step S350. The distance between the body BD and the wall is greater than the reference distance a when the distance H is positive. The distance between the body BD and the wall is shorter than the reference distance a when the distance H is negative.

Then, the deviation angle θ by which the traveling direction of the body deviates from the travel line parallel to the wall is calculated by using Expression (1): tan θ=H/L in step S360. In step S370, the body BD is turned through an angle of −θ to correct the traveling direction of the body BD. Then, a traveling direction correcting procedure is executed in step S370 to correct the deviation angle θ by which the traveling direction of the body BD deviates from the travel line. The turning of the body BD is regulated on the basis of the output of the gyroscopic sensor 37.

Then, a query is made in step S380 to see if there is a wall ahead of the body BD; that is, a query is made to see if the ultrasonic sensors 31 detected a wall standing ahead of the body BD. The parallel-to-wall traveling procedure returns to step S310 if the response to the query made in step S380 is negative or the parallel-to-wall traveling procedure is ended if the response to the query made in step S380 is affirmative.

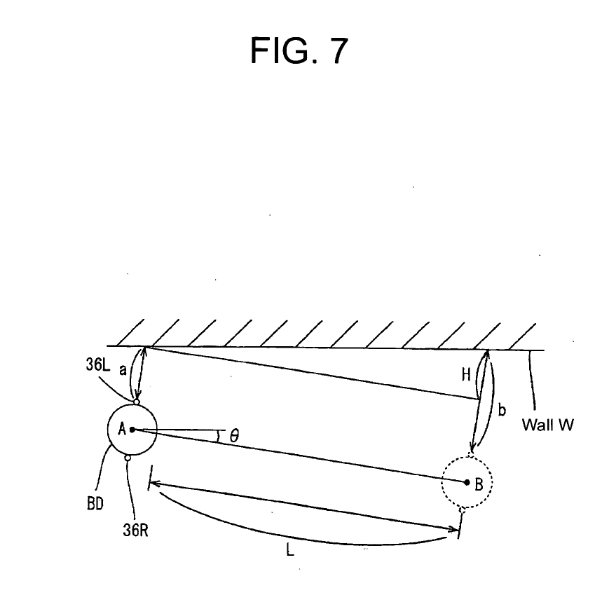

The parallel-to-wall traveling procedure shown in FIG. 6 will be concretely described with reference to FIG. 7. Suppose that the direction of the body BD is inclined slightly to a line parallel to the wall W standing beside the body BD, for example, due to an error in the output of the gyroscopic sensor 37 after the body BD has been turned through an angle of 90° in step S230 of the automatic cleaning procedure shown in FIG. 4. The distance a between the body BD and the wall W is measured by the side-wall detector 36L in step S300. The body BD starts traveling in step S310. Then, the rotary encoders 37 start measuring the travel distance in step S320.

The body BD is stopped after the body BD has traveled the predetermined distance L, i.e., when the response to the query made in step S330 is affirmative. The distance b between the body BD and the wall W is measured by the side-wall detector 36L in step S340. Then, the distance H of deviation of the body BD from the travel line parallel to the wall W is calculated by using the expression H=b−a in step S350. Then, the deviation angle θ by which the traveling direction of the body BD deviates from the travel line parallel to the wall W is calculated by using tan θ=H/L in step S360. As shown in FIG. 7, the deviation angle θ is the angle between the wall W and the traveling direction of the body BD. The body BD is traveling parallel to the wall W if θ=0. The body BD is traveling away from the wall if θ>0. The body BD is traveling toward the wall W if θ<0.

The traveling direction of the body BD is corrected on the basis of the calculated deviation angle θ in step S370, More specifically, the body BD is turned through an angle of −θ so that the traveling direction of the body BD is parallel to the wall W. Steps S310 through S370 of the parallel-to-wall traveling procedure shown in FIG. 6 are executed repeatedly to calculate the distance H of deviation of the body BD from the travel line parallel to the wall W, namely, the difference between the distances a and b, and the deviation angle θ every time the body BD travels the predetermined distance L to correct the traveling direction of the body BD. Consequently, the distance a between the body BD and the wall W is maintained and the body BD travels along the wall W.

(4) Modifications

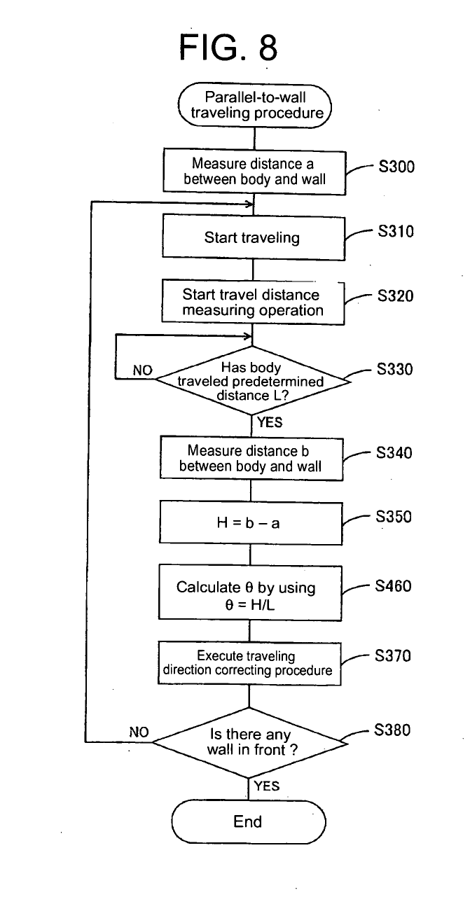

Expression (2): θ=H/L may be used instead of Expression (1): tan θ=H/L for calculating the deviation angle θ when it is expected that the deviation angle θ is very small. When Expression (2) can be used, a parallel-to-wall traveling procedure shown in FIG. 8 may be carried out. The parallel-to-wall traveling procedure shown in FIG. 8 has step S460 instead of step S360 of the parallel-to-wall traveling procedure shown in FIG. 6.

(5) Effect of the Invention

As apparent from the foregoing description, the self-propelled cleaner 10 embodying the present invention calculates the deviation angle θ by using Expression (1): tan θ=H/L, where L is the predetermined travel distance, H is the distance between the body BD and the wall W standing beside the body BD after the body BD has traveled the predetermined distance, when the body BD travels parallel to the wall W maintaining the distance a from the wall W. The traveling direction of the body BD is corrected on the basis of the calculated deviation angle θ by using the output of the gyroscopic sensor 37. Thus the deviation angle by which the traveling direction of the body BD deviates from a correct traveling direction parallel to the wall standing beside the body BD can be calculated by a simple calculating method, the traveling direction of the body BD can be corrected so that the body BD travels accurately along the wall.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A self-propelled cleaner capable of traveling along a travel line parallel to and at a fixed distance from a wall, and provided with a body, a drive mechanism capable of carrying out steering and driving operations, a cleaning mechanism, a gyroscopic sensor capable of determining an angular direction of the body, rotary encoders for counting the numbers of rotation of wheels to determine a travel distance, and wall detectors for detecting walls, said self-propelled cleaner comprising:
a calculating processor for calculating a deviation angle by which the traveling direction of the body deviates from a travel line parallel to the wall by using:
tan θ=H/L (1)
or θ=H/L (2)
where θ is deviation angle, L is a predetermined travel distance and H is a distance of deviation of the body from the travel line parallel to the wall; and
a traveling direction correcting mechanism for correcting the traveling direction of the body on the basis of the calculated deviation angle θ calculated by the calculating processor.

2. A travel device capable of traveling along a travel line parallel to and at a fixed distance from a wall, and provided with a body, a drive mechanism capable of carrying out steering and driving operations, a gyroscopic sensor capable of determining an angular direction of the body, a travel distance measuring mechanism for measuring a travel distance, and side-wall detectors for detecting obstacles lying beside the body, said travel device comprising:
a calculating processor for calculating a deviation angle by which the traveling direction of the body deviates from the travel line parallel to the wall by using:
tan θ=H/L (1)
where θ is deviation angle, L is a predetermined travel distance and H is distance of deviation of the body from the travel line parallel to the wall; and
a traveling direction correcting mechanism for correcting the traveling direction of the body on the basis of the calculated deviation angle θ calculated by the calculating processor.

3. A travel device capable of traveling along a travel line parallel to and at a fixed distance from a wall, and provided with a body, a drive mechanism capable of carrying out steering and driving operations, a gyroscopic sensor capable of determining an angular direction of the body, a travel distance measuring mechanism for measuring a travel distance, and side-wall detectors for detecting obstacles lying beside the body, said travel device comprising:
a calculating processor for calculating a deviation angle by which the traveling direction of the body deviates from the travel line parallel to the wall by using:
θ=H/L (2)
where θ is deviation angle, L is a predetermined travel distance and H is distance of deviation of the body from the travel line parallel to the wall; and
a traveling direction correcting mechanism for correcting the traveling direction of the body on the basis of the calculated deviation angle θ calculated by the calculating processor.

4. The travel device according to claim 2, wherein the distance H of deviation is calculated by using an output of the side-wall detector.

5. The travel device according to claim 2, wherein the travel distance measuring mechanism includes rotary encoders capable of counting the number of rotation of wheel.

6. The travel device according to claim 2 further comprising a cleaning mechanism and serving as a self-propelled cleaner.

7. The travel device according to claim 7, wherein the driving mechanism includes two motor drivers, right and left driving wheels, two wheel driving motors respectively for driving the right and the left driving wheel, and gear trains interlocking the wheel driving motors and the driving wheels, the motor drivers drive the wheel driving motors and minutely control the respective directions and angles of rotation of the wheel driving motors when the body is turned, and the motor drivers provide driving signals corresponding to control instructions provided by a CPU.

8. The travel device according to claim 7, wherein the body is provided with rotary encoders respectively combined with the wheel driving motors to count the respective numbers of rotation of the driving wheels, and a distance traveled by the body is calculated by using the counted numbers of rotation of the driving wheels.

9. The travel device according to claim 8, wherein the rotary encoders are attached to driven wheels disposed near the driving wheels and supported for rotation, and the rotary encoders counts the numbers of rotation of the driven wheels so that numbers of rotation for which the driving wheels should rotate, respectively, even in a state where the driving wheels slip.

10. The travel device according to claim 2, wherein the side-wall detectors are front side-wall detectors placed in a right and a left part, respectively, of a front surface of the body and each being a photodetector including an infrared emitting device that emits an infrared beam and an infrared receiving device that receives an infrared beam emitted by the infrared emitting device and reflected by a wall, and back side-wall detectors placed in a right and a left part, respectively, of a back surface of the body and each being a photodetector including an infrared emitting device that emits an infrared beam and an infrared receiving device that receives an infrared beam emitted by the infrared emitting device and reflected by a wall, each side-wall detector provides a higher output signal when a distance between the body and a side wall standing beside the body is shorter, and the travel of the body is controlled on the basis of the outputs of the side-wall detectors such that a fixed distance is maintained between the body and the side wall.

11. The travel device according to claim 2, wherein the gyroscopic sensor is provided with an angular velocity sensor capable of measuring a change in the angular velocity of the body when the traveling direction of the body changes and the angular direction of the body is determined by integrating outputs of the angular velocity sensor representing measured changes in the angular velocity of the body.

12. The travel device according to claim 2, wherein a CPU 21 serving as a controller, a ROM and a RAM are contained in the body and are connected to a bus, and the CPU performs various control operations according to control programs and parameter tables stored in the ROM and uses the RAM as a work area.

13. The travel device according to claim 12, wherein the CPU controls the calculating processor and the traveling direction correcting mechanism, the CPU carries out, when the body travels along a wall, a parallel-to-wall traveling procedure including the steps of:
determining an initial distance a between the body and the wall standing beside the body by calculation based on the intensity of the infrared beam received by the infrared receiving device and a table showing distances respectively corresponding to intensities of the infrared beam;
driving the wheel driving motors such that the body travels straight ahead;
starting a travel distance measuring operation for calculating a distance traveled by the body by using the respective numbers of rotation of the driving wheels counted by the rotary encoders of the travel distance measuring mechanism;
determining whether or not the body has traveled the predetermined distance L after the body started traveling on the basis of outputs of the rotary encoders, and measuring a distance b between the body and the wall by using an output of the side-wall detector when it is decided that the body has traveled the predetermined distance L;
calculating the distance H of deviation of the body from the travel line parallel to the wall after the body has traveled the predetermined distance L by using an expression: H=b−a;
calculating the deviation angle θ by which the traveling direction of the body deviates from the travel line parallel to the wall by using Expression 1): tan θ=H/L; and
turning the body through an angle of −θ to correct the traveling direction of the body by regulating turning of the body on the basis of the output of the gyroscopic sensor.
